(19) United States
(12) Patent Application Publication
(10) Pub. No.: US 2024/0368499 A1
(43) Pub. Date: Nov. 7, 2024

(54) Candle Wick Centering tool

(71) Applicant: Aaron James Jesse, Oroville, CA (US)

(72) Inventor: Aaron James Jesse, Oroville, CA (US)

(21) Appl. No.: 18/142,617

(22) Filed: May 3, 2023

(51) Int. Cl. C11C 5/02

(52) U.S. Cl. CPC C11C 5/02

(57) ABSTRACT

A candle wick centering and setting tool used in candle making. The tool is comprised of a body, generally cylindrical with length along the y axis. A tube or tubes running parallel to, or inside the body, along the y axis, to hold and place a wick assembly. Adjustable legs attached to the body with terminations that make contact with the 90-degree angle at the bottom of a vessel. Also, a system to transfer motion from the body of the machine to the adjustable legs, when the terminations make contact with the vessels sides and bottom simultaneously, the wick is than pressed into the center of the candle vessel and then the machine is removed.

### TECHNICAL FIELD

This application relates in general to an article of manufacture for finding the center of the bottom of a right cylindrical vessel, and more specifically, for setting a candle wick, in the center of a right circular vessel.

### BACKGROUND

Candle making Is becoming an increasingly popular hobby. According to smallbusiness.chron.com, In 2019 the candle industry in the U.S. was valued at $3.54 billion, and by 2027 is projected to grow to $6.65 billion. Grand View Research says, in 2022, North America accounted for 33% of global candle sales valued at $12.88 billion.

The prosses of assembling a container candle is basic. Placing a wick assembly in a container is an unavoidable step in most container candle processes, hobby or manufacturing. Large scale candle manufactures have automated machines that center and place the wick in mass production lines.

The traditional method of placing candle wicks in vessels by hand, is simply press the wick into center of the vessel as best a person can. If a candle wick is not placed in the center of the vessel, it causes uneven melting of the wax and heat distribution that can lead to fire hazard. The taller vessels can prove more difficult to set wicks in as well, limiting some candle makers. There have been several attempts to fill the need for a wick centering tool. The novel approach this invention takes will give home candle makers and manufacturing facilities a faster easer more accurate way to set candle wicks by hand and machine power, improving production, and product quality. The tool will make setting candle wicks, in vessels much easier and faster.

### SUMMARY

In Accordance with the preset invention, the above and other problems are solved by providing an article of manufacture for a candle wick centering tool according to the examples, principals and embodiments disclosed herein.

In a first aspect, the present invention is an article of manufacture for providing a candle wick centering and placing tool. The candle wick centering tool consists of telescopic and or articulated appendages, arranged in an evenly spaced pattern around a relatively cylindrical body, with one end attached to the body and the other moving toward, and away from the center of the throat tube. The throat tube will slide up and down a shaft in the body, resting in the up position per elastic tension. The throat tube will have an opening on one end, to allow a candle wick, to be slid inside, up the tube until the wick tab makes contact with the bottom of the tube. The wick assembly will be held in this position by the tab neck. A push handle will be on the other end of the throat tube, this will be considered the top end of the candle wick centering tool. The legs, arranged near the bottom of the tools body, will retract under human power, allowing a person to place the candle wick centering tool into a vessel. Once the machine in placed, inside an intended vessel, the legs are allowed outward movement by relieving the elastic tension via the handle on the body. Terminations at the end of the legs will contact the right angle at the bottom of the cylindrical vessel. Once center is achieved visually, a person presses down on the top of the wick tube, bonding the wick to the center of the bottom of the vessel via adhesive tab. The legs of the device are then pulled back and the machine is removed leaving the wick stuck in the center of the intended vessel.

One feature of the candle wick centering tool is the telescoping and or articulated legs. This will allow for use in a range of vessel sizes and shapes.

Another embodiment of the candle wick centering tool uses a series of cogs and or roller chain to accomplish consistent motion and power transfer throughout travel of the plurality of legs, matching the travel distance for each leg to its counter parts. This negates the need for hash marks and visual inspection as the center of the machine between all legs remains constant. This would also allow the feature of an offset design.

The forgoing has outlined rather broadly some of the features and advantages of the present invention, so the detailed description of the invention that follows may be better understood. Additionally features and advantages of the invention will be described, that form the subject of the clams of the invention.

It should be appreciated by those skilled in the art that the conception and specific embodiments disclosed may be readily utilizes as a basis for modifying or designing other structures for carrying out the same purposes of the present invention. It should also be realized by those skilled in the art, such modifications, and designs, do not depart from the spirit and scope of the invention as set forth in the appended claims. The novel features that are believed to be characteristic of the inventions advantages will be better understood from the following descriptions when considered in connection with the accompanying figures. It is to be expressly understood, however, that each of the figures is provided for the purpose of illustration and description only and is not intended as a definition of the limits of the present invention.

### BRIEF DESCRIPTIONS OF DRAWINGS

It is to be understood that no part of the example art is to scale.

Referring now to the drawings in which like references numbers represent corresponding parts throughout:

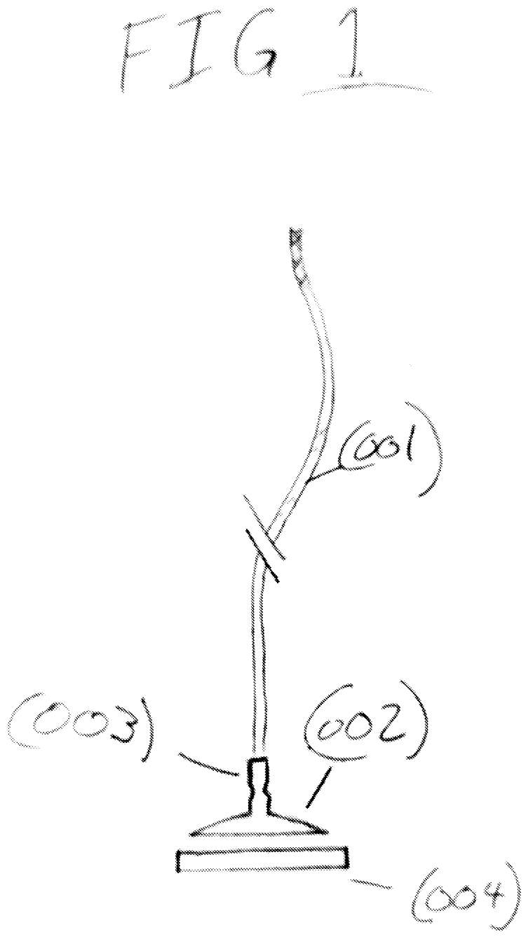

i. FIG. 1 Illustrates a candle wick assembly.

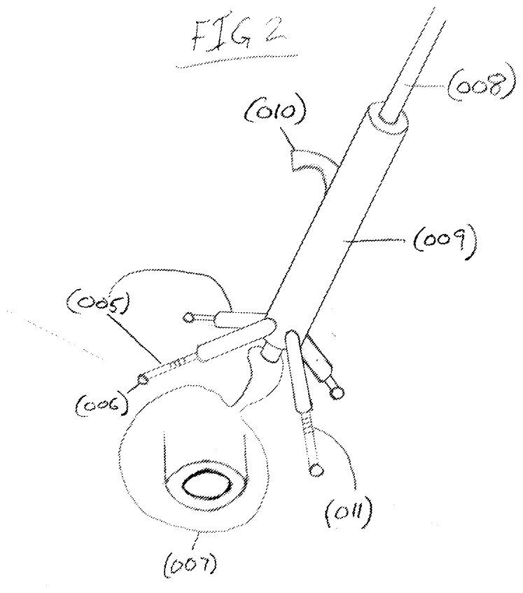

ii. FIG. 2 Illustrates a perspective view of an example embodiment of an article of manufacture providing a candle wick centering tool using telescoping legs.

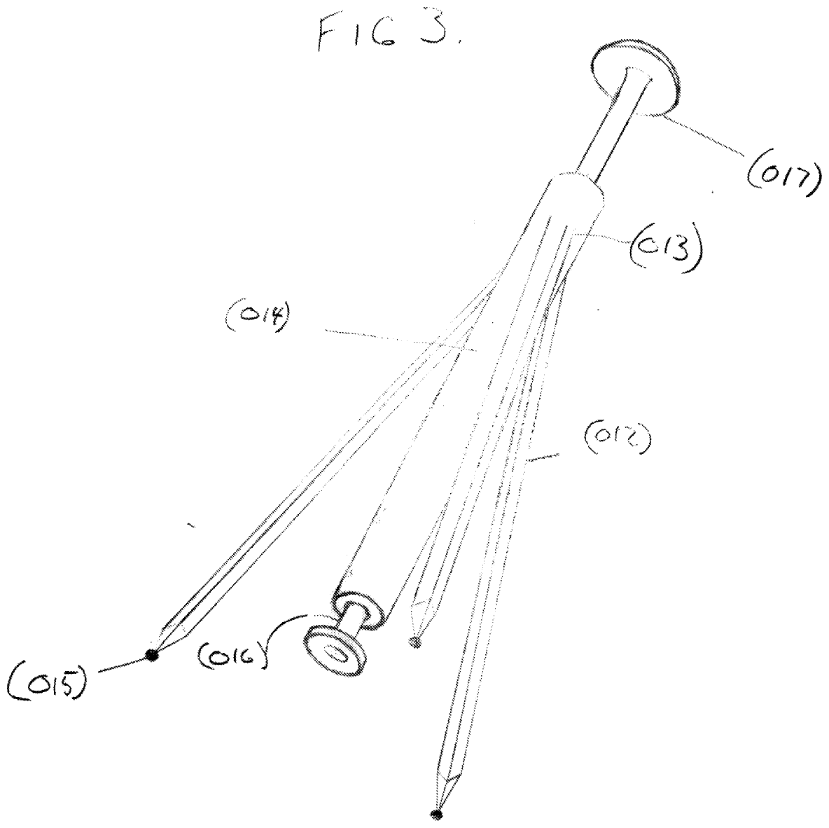

iii. FIG. 3 Illustrates a perspective view of an example embodiment of the candle centering tool using articulated legs.

### DETAILED DESCRIPTION

This application in general, relates to an article of manufacture for providing a candle wick setting device, and more specifically to an article of manufacture providing a candle wick assembly, centering and setting device, according to the present invention.

Various embodiments of the present invention will be described in detail with reference to the drawings, wherein reference numbers represent parts and assemblies throughout the total.

The following description recites various aspects and embodiments of the inventions disclosed herein. No particular embodiment is intended to define the nature and scope of the invention. Rather, the provided embodiments are non-limiting, reference examples. Additionally, examples set forth in these specificalities are not intended to be limiting and merely set forth some of the many possible embodiments of the claimed novel invention.

In Describing embodiments of the present invention, the following terminology will be used. This disclosure may utilize other terms and phrases not expressly defined herein. Such terms and phrases shall have the meaning they would posses within the context of this disclosure that they would posses by someone skilled in the art. As used herein, a plurality of items, structural elements, and compositional elements, may be expressed as a common term for convenience.

The singular forms “a,” “an” and “the” include plural referents, unless the context clearly dictates otherwise.

It should be understood the the terms “comprises,” “comprising,” “includes,” and “including” specify the presence of stated features, steps, or components, but do not preclude the presence of addition of one or more other features, steps or components. It should also be apricated by those skilled in the art, that in different embodiments, some functions or acts may take place out of order.

Furthermore, the terms “individual,” “user” and “operator” refer to an entity, artificial or human, using the candle wick centering tool.

The term “invention,” “present invention,” “embodiment,” or “machine,” refers to the disclosed invention being applied for via the patent application with the title “Candle Wick Centering Tool.” The word invention may be used interchanged with “candle wick tool,” “wick tool” and “tool.”

As used herein the term “for example,” “example,” “including,” “such as,” “for instance,” are meant to introduce examples and further clarify more vague and general subject matter. Unless expressly indicated such examples are provided only for better understanding embodiments illustrated in the present disclosure and are not meant to be limiting in any way. Nor do these indicate preference in any example embodiment of the disclosed invention.

The wick assembly, FIG. 1, is comprised of, the candle wick itself (001), the wick tab (002), that is mechanically connected to one end of the wick. The neck (003) is a hollow cylindrical protrusion from one side of the wick tab, that excepts and holds the wick to the tab via mechanical connection. An adhesive layer (004) that is bonded to the tab, opposite the wick and neck, makes up the final component of the wick assembly. This assembly of components will be known as the “wick.” This description and the accompanying art have been provided for reference and knowledge only, so that the Candle Wick Centering Tool might be better understood, and in no way does this application intend to reflect any article to the contrary. Furthermore, it is to be understood that the prescribed components of the wick are assembled, prier use with this tool.

The term “legs”, FIG. 2 (005) FIG. 3 (012), will refer to the articulated and or telescoping appendages attached to the main body of the machine. The termination at the end of these legs, that contact the intended vessel, will be known as the “feet” FIG. 2 (006) FIG. 3 (006)

### EXEMPLARY EMBODIMENTS

In general, the present disclosure relates to an article of manufacture providing a tool to find center in the bottom of a vessel. More specifically it relates to a candle wick centering and setting tool. The present disclosure describes different embodiments this tool might take so someone schooled in the art might better understand the intention of the tool.

The basic concept of this machine is, center and place a wick inside a vessel using points of contact from the right angle at the bottom of a right vessel. The example embodiments focus on right cylindrical vessels. The tool will hold the wick assembly during this prosses. After center is established, the wick assembly will be pressed into place, in the center of the bottom surface of the vessel. The machine is removed and the wick is left standing directly in the center of the vessel intended to be filled.

One embodiment, FIG. 2, the operator, will place a wick assembly inside the small hole of the center shaft of the tool (007), using a gentle pushing motion. The operator stops pushing when the tab makes contact with the bottom end (007) of the wick shaft (008). The wick will be held in this position with friction, between the wick tabs neck, and tool, via grommet or the like, until the machine is lifted out and the wick assembly is left stuck in the center of the intended vessel.

The “wick shaft,” (008) is a hollow tube, that is at the center of this embodiment and moves along the y axis of the machine, inside the main body (009). The wick shaft will be held in the upper most position via resilient force, housed in the body of the candle wick centering tool.

The body of this tool (009), is cylindrical in shape. The body has a handle (010) that will slide along the Y axis of the machine body. This will control the motion needed in the legs (005) of the tool. This motion will be will be transferred via wire rope, inside the body of the machine, to the legs.

The retractable legs will be held in the outer most position via elastic force, no greater than an average person can overcome with one or two fingers. These legs will have evenly spaced, matching hash marks with clear identifiers on the plurality (011).

When the slide handle (010) on the machine is pulled up the legs retract allowing the tool, with the wick temporally attached, to be inserted into the intended vessel. After the tool is close to the bottom of the vessel, the operator releases the elastic tension being held by the slide handle, this allows the legs to telescope outward. This will cause the tool to make contact with the vessel. the operator than pushes the tool down inside the vessel until the feet (006), located at the end of the legs make contact with the bottom of the vessel at the 90-degree angle where the bottom of the vessel and the wall come together.

Once contact with 90-degree angle is insured, the operator than uses the corresponding hash marks on each leg, to ensure each leg is of equal distance in length. This will place the wick shaft in the center of the intended vessel. After this is achieved, the operator, holding the body of the machine in one hand will press down on the top of the wick tube with the other.

Overcoming the elastic tension on the wick tube, the operator continues a downward motion until the wick tab makes contact with the bottom of the vessel. The Operator than pulls up on the slide handle, causing the legs to retract. The Machine is than removed from the vessel leaving the wick assembly attached to the center of the bottom of the vessel via adhesive.

One feature of the tool may be partial or all removal of the motion and power transfer components.

Another feature of this tool may be an opening, running the length of the body and wick shaft of the machine. This will aid in placing the wick in the tool.

Another feature of the Candle Wick Centering Tool may be replacing the static friction holding device at the bottom of the wick tube, FIG. 2 (007) with a mechanically activated design. This will allow for a more diverse acceptance of wick tab neck diameters.

In another embodiment, FIG. 3 the Candle Wick Centering Tool uses a rotating joint (013), to accomplish leg attachment (012) and movement. The plurality of legs swing away from the body (014) of the tool, healed in the outermost position via elastic tension, with terminations (015), that make contact with the right angle at the bottom of a vessel. For example, think of a tripod that holds an electronic device, with a body and wick shaft running through the center. After the operator places a wick assembly inside the tools wick shaft (016), the operator pulls the handle located on the body of the tool. The handle, transfers motion and force to hardware, inside the tools body, that connects to individual wire rope, that is connected to the leges at the other end. With the legs of the machine retracted enough as to fit inside the circumference of the intended vessel, the operator than places the tool inside the vessel, feet first, until close to the bottom of the vessel. Once close to the bottom of the vessel the operator than release the handle, this allows the feet of the tool to make contact with the sides of the intended vessel, then the machine is gently pushed the remaining distance to the bottom of the vessel. Once bottom is reached, and all elastic tension is now being held by the feet of the machine at the bottom of the vessel, the operator than pushes down on the top wick tube (017) and bonds the wick to the bottom of the vessel via adhesive tab. The machine is than removed and the wick is left in the center of the vessel.

Another feature of the tool may be a gearing system to evenly control the appendages in simultaneous motion, replacing wire rope or roller chain to transfer energy. A multiple wick system may also be incorporated as well.

In another embodiment, the legs of the Candle Wick Centering Tool may remain in place.

In another embodiment transfer of motion and power is accomplished through hydraulic or pneumatic force.

One schooled in art can see multiple features can be incorporated with multiple embodiments.

One schooled in art can see how this tool can be used by human, robot, or entity, with minimal modifications.

The forgoing embodiments are for example only, and in no way place restrictions on the disclosed invention herein. The possible combinations of features and embodiments described herein are intended for example reference only, and do not intend to limit disclosure of the Candle Wick Centering Tool. Many possible combinations of features and embodiments have not been discussed in this disclosure.

Unless specifically described, no action, facet, material, or feature will be constituted as critical or vital to the invention described.

1. Terminations, that make contact with the bottom of a vessel.

2. Appendages, that allow the terminations to be moved.

4. Invention will suspend the candle wick assembly until bonded to the vessel.
